(19) United States
(12) Patent Application Publication
(10) Pub. No.: US 2020/0351306 A1
(43) Pub. Date: Nov. 5, 2020

(54) CONFIGURING SECURITY POLICIES IN RESPONSE TO DETECTING A PIVOT OF AN INTRUSION

(71) Applicant: ShieldX Networks, Inc., San Jose, CA (US)

(72) Inventors: Manuel Nedbal, Santa Clara, CA (US); Ratinder Paul Singh Ahuja, Saratoga, CA (US); Sumanth Gangashanaiah, Cupertino, CA (US); Venkata Ramani Yellapragada, Calgary (CA); Xiaodong Ye, Los Gatos, CA (US)

(21) Appl. No.: 16/402,946

(22) Filed: May 3, 2019

(51) Int. Cl. H04L 29/06

(52) U.S. Cl. CPC H04L 63/20; H04L 63/1433; H04L 63/1491; H04L 63/1416

(57) ABSTRACT

Systems, methods, and apparatuses enable a security service configurator to configure security policies for network traffic sent from internal resources of a secure environment. The security service configurator receives an indication of intrusion activity in network activity directed to a first internal resource of the secure environment. The security service configurator determines the occurrence a pivot of an intrusion between the first internal resource and a second internal resource within the secure environment. In response, the security service configurator configures an extrusion detection policy for the second internal resource. When the security service configurator receives an indication of extrusion activity in network activity directed from the second internal resource to a system external to the secure environment, the security service configurator performs a security process on the network activity.

### TECHNICAL FIELD

Embodiments described herein generally relate to network security. Embodiments described herein generally relate to systems and methods for configuring security policies in response to detecting a pivot of an intrusion.

### BACKGROUND INFORMATION

Most businesses and organizations rely on computer systems and networks for an increasingly wide variety of business operations. As reliance on computing technologies has grown, so too has the importance of securing computer systems and networks against internal and external security threats. However, the breadth and complexity of security threats targeting such computer systems and networks is far and wide and ever growing. To monitor and address these security threats, organizations increasingly rely on sophisticated computer security applications and hardware such as firewalls, anti-virus tools, data loss prevention (DLP) software, etc.

### BRIEF DESCRIPTION OF THE DRAWINGS

The various advantages of the embodiments disclosed herein will become apparent to one skilled in the art by reading the following specification and appended claims, and by referencing the drawings, in which:

FIG. 1 is a block diagram of a network security system illustrating computer hardware, including a memory and processor, in accordance with the disclosed embodiments;

FIG. 2 illustrates a scalable security architecture implementing a three-time scale out using security microservices in accordance with the disclosed embodiments;

FIG. 3 illustrates an arbitrary scaling out of a microservice in accordance with the disclosed embodiments;

FIG. 4 is a block diagram illustrating a security service configured to monitor traffic sent among an application and one or more servers through a routing network in accordance with the disclosed embodiments;

FIG. 5 is a block flow diagram illustrating application data traversing to a server after passing through a hierarchy of security microservices in accordance with the disclosed embodiments;

FIG. 6 is a flow of application data through a stateless processing, fault-tolerant microservice environment in accordance with the disclosed embodiments;

FIG. 7 is a block diagram illustrating security microservices configured to detect and configure network security based on the detection of a pivot of an intrusion in accordance with the disclosed embodiments;

FIG. 8 is a flow diagram illustrating a process for reconfiguring security policies in response to detecting a pivot of an intrusion in accordance with an embodiment; and

FIG. 9 is a block diagram that illustrates a computer system utilized in implementing the above-described techniques in accordance with some of the disclosed embodiments.

### DETAILED DESCRIPTION

In the following description, numerous specific details are set forth. However, it is understood that embodiments of the disclosure may be practiced without these specific details. In other instances, well-known circuits, structures and techniques have not been shown in detail to not obscure the understanding of this description.

References in the specification to “one embodiment,” “an embodiment,” “an example embodiment,” etc., indicate that the embodiment described may include a particular feature, structure, or characteristic, but every embodiment need not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In order to dynamically apply application security settings and policies to components of an internal network, a security system utilizing a plurality of security microservices can be implemented. In conventional systems, network traffic can be logged or recorded for offline processing and security analysis after the network traffic is sent to its intended destination, which can result in malicious network traffic penetrating portions of an internal network and the extrusion of sensitive or confidential information before the security analysis can identify and/or block the malicious network traffic. In other conventional systems, all network traffic can be subjected to security processing prior to being sent to its intended destination. However, analyzing all network traffic can require significant resources and, as the amount of the network traffic increases, analyzing all network traffic in real-time can result in significant delays in legitimate network traffic reaching its destination. In other solutions, a security system can employ strict extrusion rules to help prevent data leakage (e.g., an unauthorized transmission of sensitive data from an internal network to an external system or network). However, this solution can result in the blocking of otherwise legitimate communications from the internal network to an external network. For example, because network traffic generated internally to a system is more likely to be legitimate, stringent rules can prevent legitimate traffic from reaching its destination.

To address the deficiencies of existing security infrastructures, embodiments detailed herein address the conflicting goals of employing strict extrusion detection rules to prevent any escape of confidential information and of employing permissive extrusion detection rules to minimize the impact and risk to existing processes and communication. By identifying in real-time the locations within a network that merit higher degrees of mistrust and updating these locations as potential security events occur in real-time, the application of strict detection rules can be applied only to those locations where extrusion events are likely to occur (and succeed) and computing resources required to process and analyze can be reserved for those locations.

For example, some embodiments detailed herein utilize a security service configurator to receive indications of intrusion activity in network activity directed to a first internal resource of a first system, where the intrusion activity is detected by an intrusion detector. The security service configurator can further receive an indication of a successful intrusion of the first internal resource. The security service configurator further receive an indication of a pivot of the intrusion from the first internal resource to a second internal resource within the first system. In response to detecting the pivot, the security service configurator reconfigures an extrusion detection policy for the second internal resource. When the security service configurator subsequently receives an indication of extrusion activity, from an extrusion detector, in second network activity directed from the second internal resource to a second system that is external to the first system, the security service configurator performs a security process in response to the detecting of the extrusion activity.

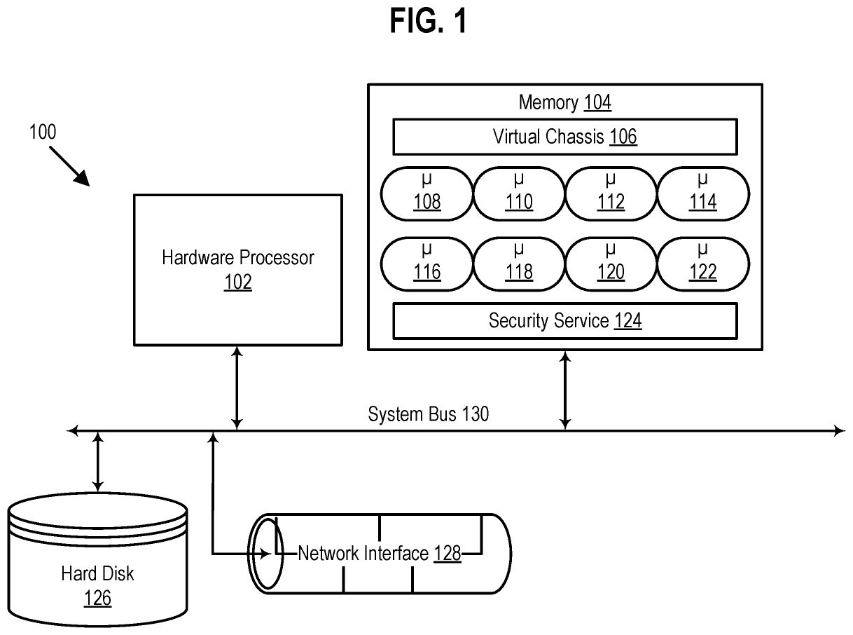

FIG. 1 is a block diagram of network security system 100 illustrating computer hardware, including a memory (e.g., 104) and processor (e.g., 102), in accordance with the disclosed embodiments. Network security system 100 further includes a hard disk (e.g., 126) and network interface (e.g., 128). In one embodiment, hardware processor 102, memory 104, hard disk 126, and network interface 128 are coupled to each other via a system bus (e.g., 130). Network security microservices 108-122 are stored in memory 104 (e.g., volatile memory such as Random-Access Memory (RAM) and/or non-volatile memory such as solid-state storage or disk) and executed by one or more processor cores or hardware processor 102. Network security microservices 108-122, consisting of computer-executable instructions to perform one or more specific security services, are deployed based on configuration across available physical servers. Typically, each microservice receives a configuration and tasks via a backplane of a virtual chassis 106, and returns status, statistics, and other information to the backplane.

The data processed by the network security system 100 is transferred from a microservice to another (higher hierarchy) microservice using a data plane. In some embodiments, during such a transfer, a lower hierarchy microservice decides (based on configuration, current statistics, and other information) as to which next microservice to utilize. Such a decision may constitute a load-balancing decision to assure that the higher hierarchy microservices are efficiently utilized. In other embodiments, the decision of which microservice to utilize is made by a more central entity.

As illustrated, network security system 100 utilizes hardware processor 102 (such as a central processing unit (CPU) or one or more cores thereof, a graphics processing unit (GPU) or one or more cores thereof, or an accelerated processing unit (APU) or one or more cores thereof) to execute microservices and other applications (e.g., virtual chassis 106, security service 124, etc.) stored in memory 104. Network interface 128 (e.g., fabric or interconnect that is wired or wireless) provides a means for communicating with a data center. Network security system 100 may inspect traffic, detect threats, generate security settings and policies (e.g., access control lists), and otherwise protect a data center using the microservices 108-122.

Embodiments of network security system 100 providing the above capabilities are now discussed in more detail. Network security system 100 adds security to, or enhances the security of, a datacenter or other computing environment. In one embodiment, network security system 100 is delivered (e.g., downloaded) in the form of a seed software application. The seed software application instantiates microservices of the network security system on a host in the datacenter. As used herein, a microservice container refers to where the microservice runs, for example, on a virtual machine. Once deployed, network security system 100 utilizes a hardware processor 102, memory 104, and network interface 128. In many scenarios, security can be added/configured using existing hardware and/or without purchasing additional rack devices for particular functionality. The seed software application may be installed on any one of a wide variety of hosts—be they slow or fast, low-cost or high-cost, commodity or customized, geographically dispersed, part of a redundancy scheme, or part of a system with regular back-ups.

In some embodiments, network security system 100 utilizes a network interface 128 to explore the datacenter and to discover existing network segments, determine security settings and policies to apply to various network segments, detect available hosts and hardware resources, and determine additional configuration information as needed. In one embodiment, the datacenter itself includes several machines with hypervisors, or physical hardware, and the network security system 100 offers microservices to communicate with and protect one or more of those internal virtual machines or physical hardware. Based on performing datacenter discovery, network security system 100, in some embodiments, may then offer or suggest available security tools for selection either through a graphical interface or via connections with existing enterprise management software. In one embodiment, once configured, network security system 100 is deployed “in-line,” receiving packets headed for the datacenter, thereby allowing network security system 100 to intercept and block suspicious traffic before it reaches the datacenter. With an understanding of the datacenter, network security system 100 deploys microservices to inspect traffic throughout the datacenter, and not only at ingress. In some embodiments, network security system 100 is deployed in a “copy only” configuration, in which the system monitors traffic, detects threats, and generates alerts, but does not intercept traffic before it arrives at the datacenter.

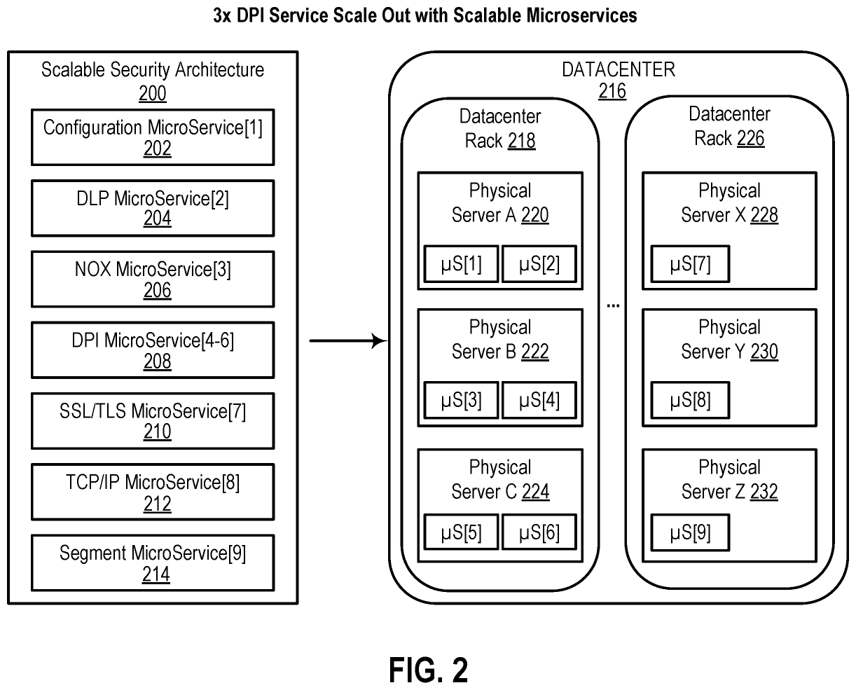

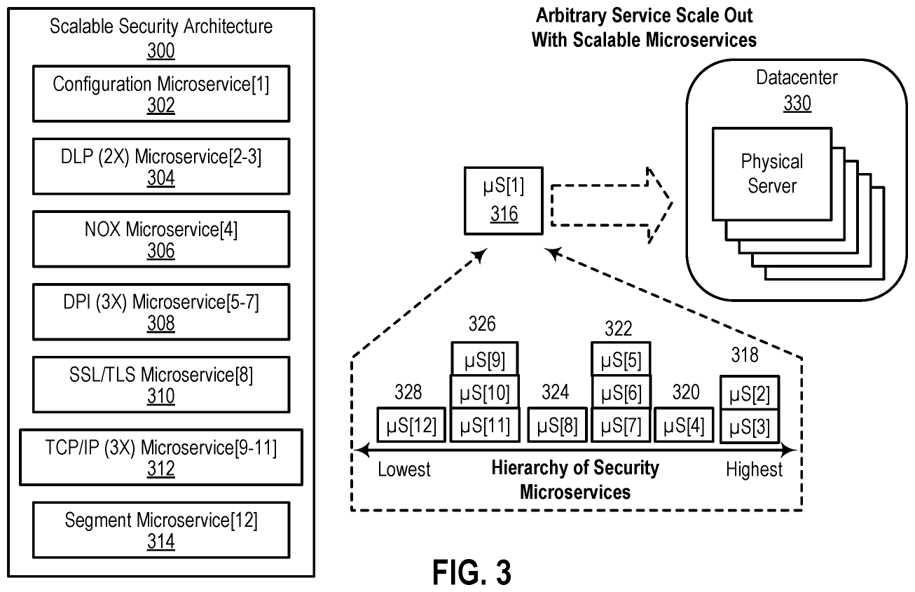

As shown, memory 104 has stored therein microservices 108, 110, 112, 114, 116, 118, 120, and 122 (108-122), as well as a virtual chassis 106, which may also be a microservice. In one embodiment, the microservices are small in size, consisting of a relatively small number of instructions. In one embodiment, the microservices 108-122 are independent of each other. As illustrated, microservices 108-122 are microservices that are loaded from memory and executed by the hardware processor 102. Those microservices 108-122 include data path security microservices, for example TCP/IP, SSL, DPI, or DLP microservices, as described further below with respect to FIGS. 2 and 3. The microservices 108-122 may also include management microservices, for example, a chassis controller to manage the microservices, a configuration microservice, an infrastructure discovery microservice, a database microservice to store data, a policy update microservice to receive policy updates from an external security cloud, and a compiler to receive policy data from various sources and to produce binary policy outputs to be used by the microservices, to name a few examples that are described hereinafter with respect to FIGS. 2 and 3.

Memory 104 also stores security service 124. Security service 124 manages the initialization and configuration of one or more of a plurality of microservices. For example, security service 124 initializes and configures a plurality of microservices to detect indications of network traffic pivot within an internal network, and subsequently reconfigure or modify intrusion and extrusion rules associated with an internal network. Security serviced 124 also configures interface microservices to perform security processing on the network traffic to prevent potentially bad or malicious network traffic from being transmitted to and/or from resources. The processes disclosed herein can be performed by security service 124 or by microservices (e.g., microservices 108-122) based on instructions from security service 124.

It will be understood by those of ordinary skill in the art that a datacenter typically employs many instances of the hardware represented within network security system 100 such as hardware processor 102 and memory 104. Individual servers may have multiple processors or multiple processing boards each with multiple processors. Processors may have a plurality of processing cores and access a plurality of network interfaces. Security service 124 comprises program code executing within a processor and may have interfaces (such as configuration or administration user interfaces) that are made available over a network to users. In a virtualized environment, the user may not be aware of the specific processor on which security service 124 is executing and, in some embodiments, that processor may change based on loading of the virtual environment. Such changes may occur based on administrator requests or automatically based on the virtual environment's control software.

In one embodiment, network security system 100 receives traffic via network interface 128 to/from a datacenter. In one embodiment, network security system 100 is placed in-line to inspect traffic, and potentially intercept a threat before it arrives at, or leaves, the datacenter. In other embodiments, network security system 100 monitors the traffic heading into, or out of, the datacenter, in which case network security system 100 detects threats and generates alerts but does not block the data. Hardware processor 102 may execute various data security microservices on the data. For example, as described hereinafter with respect to FIGS. 2 and 3, typically traffic first passes into and through a segment microservice, then a TCP/IP inspection microservice, then an SSL microservice, then a DPI microservice, then a NOX microservice, and then a DLP microservice. However, one or more of these services may not be enabled. In some embodiments, a segment microservice resides within a network segment and serves as the entry point for packets and forwards the packets to appropriate microservices for further analysis. Data path microservices as used herein refer to various microservices that inspect and analyze network traffic, such as TCP, TLS, DPI, NOX, and DLP microservices. A TCP microservice, for example, refers to a packet handling microservice able to process any layer 4-6 network packet and includes part of firewalling. A TLS microservice, for example, refers to a Transport Layer Security microservice, which decrypts/re-encrypts connections. A DPI microservice, for example, refers to a Deep Packet Inspection microservice and handles layer 7 inspection. A NOX microservice, for example, refers to a Network Object Extractor microservice, and works in conjunction with DPI to assemble objects from individual packets and to deliver the objects to other services. A DLP microservice, for example, refers to a Data Loss Prevention microservice, which detects and attempts to prevent data loss. Control path microservices, on the other hand, are various microservices, such as a factory, a compiler, a configuration, an infrastructure discovery, a database, a messenger, a scaler, and a chassis controller, that are instantiated in, and make up, a management plane. Threats detected by the aforementioned microservices, in one embodiment, are reported to a chassis controller microservice, which takes remedial action.

In one embodiment, microservices 108-122 are implemented using computer-executable instructions loaded from the Internet via network interface 128. For instance, in one embodiment, the microservices are implemented with computer-executable instructions downloaded from a web site or online store site. In some embodiments, microservices 108-122 are loaded into memory 104. In various embodiments, the microservices are implemented using computer-executable instructions loaded on and received from a non-transitory computer-readable medium, such as digital media, including another disc drive, a CD, a CDROM, a DVD, a USB flash drives, a Flash memory, a Secure Digital (SD) memory card, a memory card, without limitation. Microservices received from a digital medium may be stored into memory 104. The embodiments are not limited in this context. In further embodiments, a digital medium is a data source that constitutes a combination of hardware elements such as a processor and memory.

In most embodiments, network security system 100 runs on a datacenter computer. In other embodiments, however, network security system 100 is installed and runs on any one of a wide variety of computing platforms, ranging from low-cost to high-cost, and from low-power to high power. In some embodiments, network security system 100 runs on a server. In some embodiments, network security system 100 is installed on and runs on a low-cost, commodity server computer, or on a low-cost rack-mounted server. As illustrated, hardware processor 102 is a single core processor. In alternate embodiments, hardware processor 102 is a multi-core processor. In alternate embodiments, hardware processor 102 is a massively parallel processor. In some embodiments, a virtual chassis 106 and microservices 108-122 may be hosted on any of a wide variety of hardware platforms used in the datacenter to be protected.

In some embodiments, network security system 100 scales out using available resources to accommodate higher traffic or load. In one embodiment, hardware processor 102 (CPU) and memory 104 are scaled out or in dynamically as needed: additional CPUs and memory are added if scaling out, and some CPUs and/or memory are powered down if scaling in. This scaling out is performed to allocate the additional CPUs and memory to those portions of the security hierarchy for which there is demand, while not allocating additional CPUs and memory to those portions of the security hierarchy that can accommodate the higher traffic utilizing their existing allocation.

One property of a microservice is the separation and protection of memory from other microservices. In this manner, an individual microservice may be moved to another physical server or terminate abnormally without impacting other microservices. Microservices may be distinguished from threads in that threads generally operate within a shared memory space and exist within the confines of an operating system on which the microservices were spawned.

FIG. 2 illustrates an example scalable security architecture implementing a three-time scale out using security microservices. In the example of FIG. 2, only a single microservice (e.g., a DPI microservice) has a demand for additional resources. As shown, by utilizing a scalable microservice architecture 200, including DLP microservice 204, NOX microservice 206, DPI microservice 208, SSL/TLS microservice 210, TCP/IP microservice 212, and segment microservice 214, each level of the security service hierarchy can be scaled and configured independently to load balance the supply of processed data to the next hierarchy level. As shown, datacenter 216 includes datacenter rack 218, which includes physical server A 220, physical server B 222, and physical server C 224. As shown, a datacenter rack 226 includes physical server X 228, physical server Y 230, and physical server Z 232. DPI microservices 208 have been scaled out 3X, and in this instance assigned to be performed as microservices 4-to-6 on physical server B 222 and physical server C 224. The remaining microservices of scalable security architecture are shown as being implemented by physical servers A, X, Y, and Z (220, 228, 230, and 232, respectively). A configuration microservice 202 creates a configuration backplane and a data plane deployed as a software component on each physical server that is to receive security services. This process includes configuring routing rules, reserving network address space (such as a subnet), and configuring virtual environments to utilize portions of the reserved address space as gateways for network communication in and out of the servers to be secured. Both the backplane and data plane may thus be considered virtual networks managed by the security system. Security microservices may then utilize these networks to transmit packets, content, state, and other information among the microservices. The properties of the backplane and data plane are configured to reject packet traffic from outside the security system and to route information between microservices regardless of the physical server and virtual environment configuration.

FIG. 3 illustrates an arbitrary scaling out of a microservice according to an embodiment. As shown, scalable security architecture 300 includes configuration microservice 302, DLP (2X) microservice 304 (a 2-times scale-out), NOX microservice 306, DPI (3×) microservice 308 (a 3-times scale-out), SSL/TLS microservice 310, TCP/IP (3X) microservice 312 (a 3-times scale-out), and segment microservice 314. As shown, configuration microservice 316 provisions (318, 320, 322, 324, 326, and 328) the 11 microservices from a lowest hierarchy to a highest hierarchy and configures them to communicate with each other via a backplane. The microservices, for example, may be implemented by physical servers in datacenter 330.

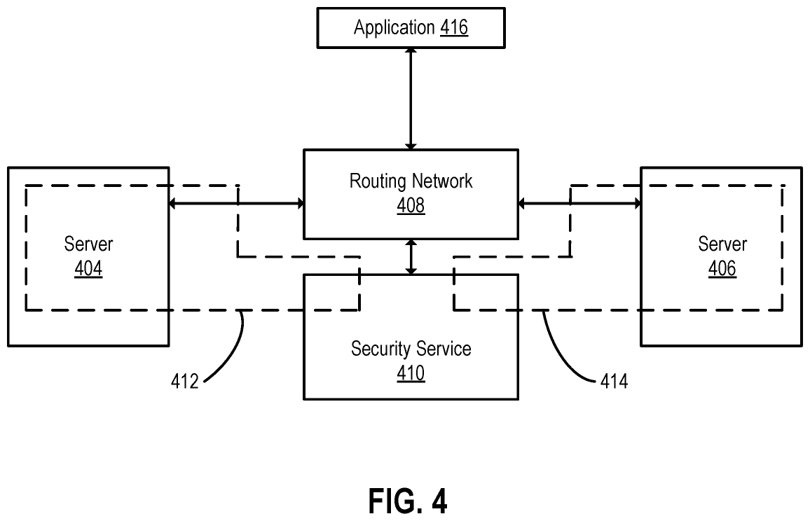

FIG. 4 is a block diagram illustrating a networked computing environment in which an embodiment may be implemented. FIG. 4 represents an example embodiment that is provided for purposes of illustrating a clear example; other embodiments may use different arrangements.

The networked computer system depicted in FIG. 4 comprises one or more computing devices. These one or more computing devices comprise any combination of hardware and software configured to implement the various logical components described herein. For example, the one or more computing devices may include one or more memories storing instructions for implementing the various components described herein, one or more hardware processors configured to execute the instructions stored in the one or more memories, and various data repositories in the one or more memories for storing data structures utilized and manipulated by the various components.

In one embodiment, one or more security services 410 may be configured to monitor network traffic and other data sent between application 416 and one or more servers 404 and 406 through a routing network 408. In one embodiment, security service 410 is an example of security service 124 in FIG. 1. In one embodiment, security service 410 comprises one or more “microservices” (e.g., microservices 108-122 in FIG. 1) used to monitor and perform various actions relative to data items (e.g. network traffic, files, email messages, etc.) sent to and received from one or more applications 416 and servers 404 and 406. The microservices comprising security service 410 do not need to be confined to one physical server such as a server 404 and 406. For example, one or more microservices of the security service 410 may be executed on server 404 and other microservices of the security service 410 are executed on 406. In some embodiments, the security service 410 is executed on a different server from one or more servers for which the security service is responsible for monitoring and protecting. In one embodiment, servers 404 and 406, security service 410, and application 416 are deployed in a networked environment. Examples of networked environments include data centers, an on-premise stack, and a set of servers remotely connected using a network.

In one embodiment, a routing network 408 provides connectivity among servers 404 and 406, security service 410, and application 416. In some embodiments, routing network 408 is partially configured responsive to hypervisor configuration of servers 404 and 406. In some embodiments, a routing network 408 is partially or entirely configured responsive to hypervisor configuration of servers 404 and/or 406.

In one embodiment, based on routing information included in channel data encapsulation packets, data traveling between an application 416 and server 404 and/or server 406 is routed to the correct server, and is kept separate from data traveling between the application 416 and the other server. Accordingly, what is essentially a private network 412 may be created between the server running security service 410 and server 404. Similarly, what is essentially a private network 414 may be created between the server running security service 410 and server 406.

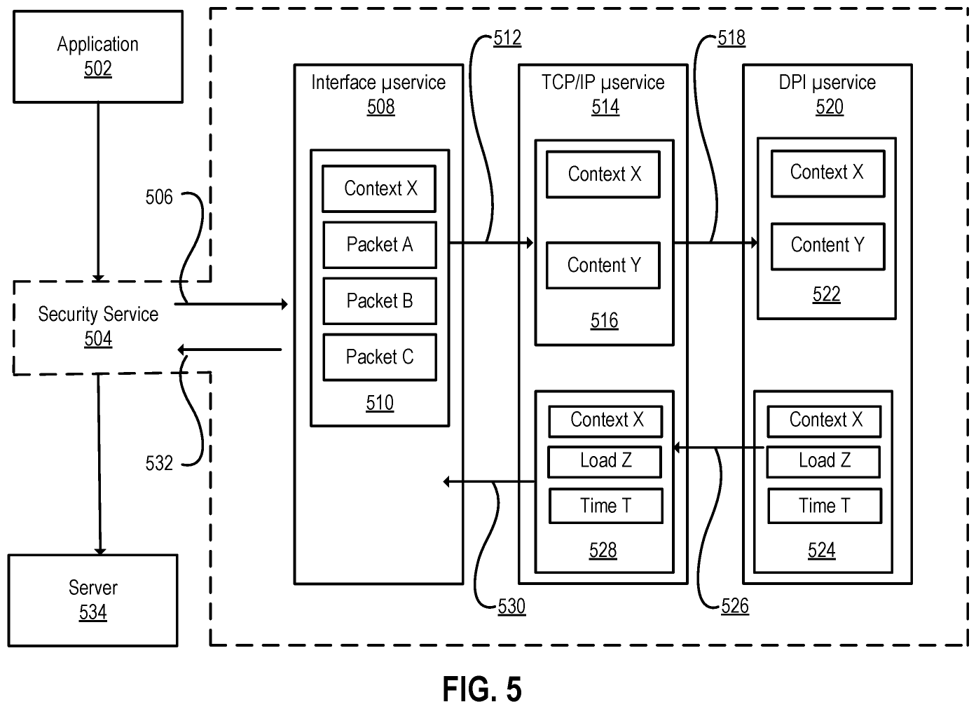

FIG. 5 is a block flow diagram illustrating application data traversing to a server after passing through a hierarchy of security microservices according to an embodiment. As illustrated, the flow begins with security service 504 receiving a network packet from application 502. In one embodiment, security service 504 is an example of security service 124 in FIG. 1. Security service 504 receives the packet (e.g., from an application or program that redirects packets to security service 504), and security service 504 forwards 506 the packet to interface microservice 508, which generates a channel data encapsulation packet 510 encapsulating three packets A, B, and C, and a context X. As shown, channel data encapsulation packet 510 encapsulates three packets, but in alternate embodiments, the number of encapsulated packets may vary without limitation. In some embodiments, context X is generated based at least on the headers of packets A, B, and C. In some embodiments, context X is generated based on a lookup of packet header fields such as IP addresses, ports, and MAC addresses for the source and destination of the packets. In some embodiments, the generation of context X includes using an interface identifier obtained from a virtualization environment. Generation of context X may be accomplished through a lookup of header fields and other data in a table, a hash of header fields and other data, or another method whereby packets for which a common security policy is to be applied are associated with a common context or common portion, such as a bit field, of the context.

Context X may be considered an identifier describing the traffic streams, source machines, or applications responsible for generating packets A, B and C. This identifier may be direct (such as an ID used as a table look up), indirect (such as a pointer used to access a data structure), or some other method of instructing microservices as to the policies and processing to use for handling packets A, B, and C. As an example, context X may be generated by performing a hash, longest prefix match, or lookup of header fields such as IP addresses, TCP ports, interface names (or MAC addresses), or other packet properties. The lookup may be an exact match, longest prefix match, or other method to associate packet streams with the same security processing to use. The generated context may then be used by security services, such as a DPI service, to determine which rules to utilize when scanning the data from packets A, B, and C (and other packets that are part of the same traffic stream). This information may be embedded within the context (as a bit field or other information), available by indirection (such as a table or data structure lookup by another service) or generated programmatically based on any combination of such information.

The context may be generated through a look up at an interface microservice and is included in the transmission of packet data to transmission control protocol (TCP) reassembly services. Reassembled content from the TCP microservice is transmitted to a deep packet inspection (DPI) microservice or secure socket layer (SSL) microservice, and with the same context. By maintaining this context in the encapsulation of data transport throughout the microservice hierarchy, processing directives associated with a context become a shared read-only resource (relative to the microservices) and may only rarely use stateful updates.

Interface microservice 508 transmits 512 the channel data encapsulation packet 510 to TCP/IP microservice 514. As shown, the channel data encapsulation packet 516 includes context X and content Y, which corresponds to packets A, B, and C of channel data encapsulation packet 510. After conducting security processing of the channel data encapsulation packet 516, TCP/IP microservice 514 transmits 518 the packet to DPI microservice 520. As shown, the channel data encapsulation packet 522 includes context X and content Y, which corresponds to packets A, B, and C of channel data encapsulation packet 510. After conducting security processing of the channel data encapsulation packet 522, DPI microservice 520 generates channel data encapsulation packet 24, which, as shown, includes context X, DPI load Z, and DPI timestamp T. Encapsulated channel data may be tagged with properties including a timestamp and a load metric. The timestamp may reference the duration of microservice processing, the time at which microservice processing started or another temporal property associated with processing the encapsulated channel data. The load metric may reference the relative or absolute loading of a microservice processing the encapsulated channel data.

As shown, a DPI microservice 520 transmits, via path 526, channel data encapsulation packet 524 to TCP/IP microservice 514, which uses the DPI load and DPI timestamp information to inform future load-balancing decisions. As shown, a TCP/IP microservice 514 generates channel data encapsulation packet 528, which includes context X, TCP/IP load Z, and TCP/IP timestamp T. As shown, TCP/IP microservice 514 transmits, via path 530, channel data encapsulation packet 528 to interface microservice 508, which uses the TCP/IP load and TCP/IP timestamp information to inform future load-balancing decisions. The flow is completed when interface microservice 508 transmits, via path 532, packets to security service 504, which transmits the packets to a server 534.

As shown, DPI microservice 520 transmits channel data encapsulation packet 524 to TCP/IP microservice 514, which uses the DPI load and DPI timestamp information to inform future load-balancing decisions. As shown, TCP/IP microservice 514 generates channel data encapsulation packet 528, which includes context X, TCP/IP load Z, and TCP/IP timestamp T. As shown, TCP/IP microservice 514 transmits channel data encapsulation packet 528 to interface microservice 508, which uses the TCP/IP load and TCP/IP timestamp information to inform future load-balancing decisions. The flow is completed when interface microservice 508 transmits, via path 532, packets to security service 504, which transmits them to server 534 microservice.

Exemplary benefits of the security service 504 may include the ability of each microservice to utilize the same channel data encapsulation protocol for all communication, thereby allowing scaling across the entirety of the datacenter network routable via the channel data encapsulation header. Communications between microservices maintain a context X generated at interface microservice 508 to all subsequent microservices that no longer have access to the original packets. As an example, a DPI microservice processing content reassembled by a TCP/IP microservice has no visibility into the packets used by the TCP/IP microservice to reassemble the content. However, the context X generated upon reception of one or more of those packets at the interface microservice, forwarded to the TCP/IP microservice and subsequently forwarded by the TCP/IP microservice to the DPI microservice, may be used to determine policy or select a minimal DPI signature set by the DPI microservice without incurring additional state processing. By providing load and timestamp data in the channel data encapsulation packets 524 and 528, which are returned via transmission paths 526 and 530, the microservices receive and can maintain real-time loading and processing latency information utilized to make load balancing decisions.

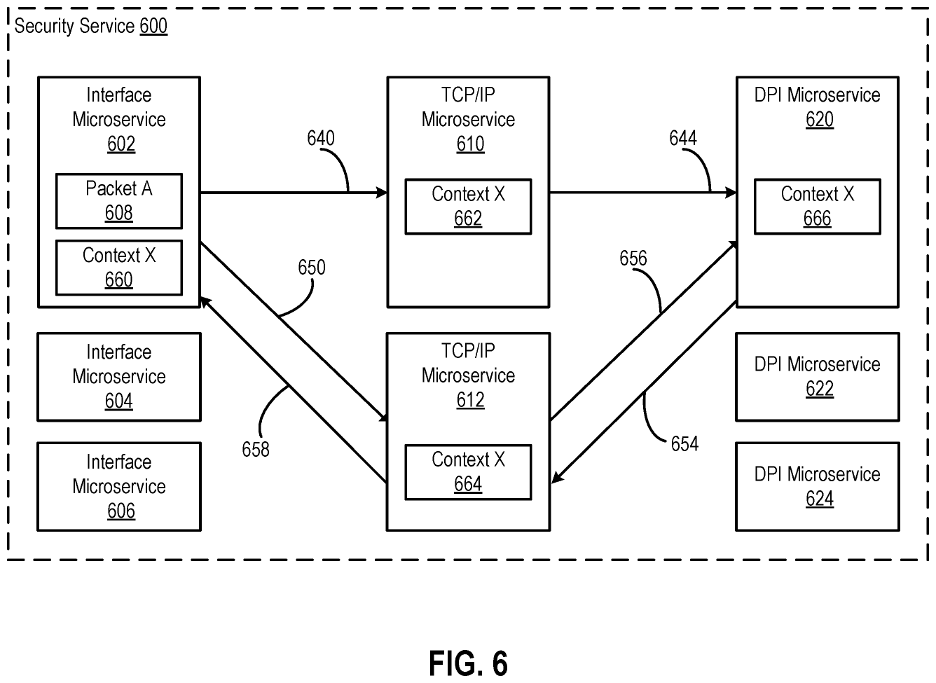

FIG. 6 is a block diagram illustrating a flow of application data through a stateless processing, fault-tolerant microservice environment in accordance with disclosed embodiments. As illustrated, security service 600 includes interface microservices 602, 604, and 606, TCP/IP microservices 610 and 612, and DPI microservices 620, 622, and 624. Other examples include a different number of microservices and/or a different number of microservice types. In one embodiment, security service 600 is an example of security service 124 in FIG. 1. In the example of FIG. 6, an interface microservice 602 receives packet A 608, and generates a context X 660.

One benefit of the security system illustrated in FIG. 6 is the handling of state. For example, if packets belong to a certain context X, the security service 600 may enable both TCP/IP microservices 610 and 612 to perform meaningful work on the packets. By implementing TCP/IP processing as microservices 610 and 612 with an external state structure and a context that accompanies processed data, each TCP/IP microservice, and any other microservice at every level of the security hierarchy, can be isolated from other microservices and can be scaled independently. Each microservice can access the state for any packet or reassembled packet data, thereby enabling real-time load balancing. In many cases, the context enables microservices to forego consulting service state (state associated with processing at the hierarchy level of the specific microservice), thereby reducing the demands on the global state repository.

As an example, consider the context X 662 obtained by TCP/IP microservice 610 as part of packets received from interface microservice 602 as transmission path 640. Context X 662, when transmitted to DPI microservice 620 as part of transmission path 644, along with the reassembled packet data, contains information that may enable the DPI microservice to forego or simplify processing of this reassembled data. Such information can include, for example, a context bit or field specifying a subset of regular expressions or patterns to be used for DPI processing, a number of bytes of reassembled data to be received before beginning DPI processing, specific allowed or disallowed protocols, and other information potentially avoiding a DPI state lookup.

In an embodiment, microservices of a security service 600 are stateless. For example, each of the microservices may retrieve state information from an outside source such that the microservice can process packets or content belonging to any context. Each microservice may retrieve and update service state (that state associated with the microservice processing). Additionally, each microservice may retrieve and update context state (state associated with the context relevant for all security service processing). In some embodiments, the process state and context state share a global state service. Examples of elements of context state include a level of suspicion regarding traffic from a source IP, a policy to ignore certain ports or protocols, and other information used to process the packets, reassembled content, and extracted objects from communication identified with the context.

In an embodiment, multiple microservices in the same or different hierarchy of the security system may be able to process packets associated with the same context at the same time. If one security microservice fails (e.g., if a TCP microservice fails to respond to a request), another microservice can take over and process the request using the failed microservice's context.

Returning to FIG. 6, the generation of context X 660 may include considering properties associated with a packet A 608 (e.g., such as an n-tuple detailing routing information), and a state lookup or a context lookup, in addition to other information. Interface microservice 602 provides packet A 608 and context X 660 to TCP/IP microservice 610 or 612 via transmission paths 640 or 650, respectively. For example, interface microservice 602 may conduct a load-balancing to select one of the TCP/IP microservices to forward the packet A 608 and the context X 660.

In an embodiment, TCP/IP microservices 610 and 612 are stateless, but may benefit from the context X generation performed by interface microservice 602. For example, whichever of TCP/IP microservices 610 and 612 receives packet A may disassemble the packet to extract the data associated with the packet and conduct security processing on the data. TCP/IP reassembly generally consists of associating packets with flows (e.g., identified by source and destination IP and port values) and using the TCP sequence numbering to place the packets into a correct order, remove any overlap or duplication, and/or identify missing or out of order packets.

In FIG. 6, TCP/IP microservices 610 or 612 forward the extracted data and/or the data resulting from the security processing to DPI microservice 620 via transmission paths 644 or 656, respectively. Along with the transmitted data, TCP/IP microservice 610 or 612 forwards context X 662 or 664, respectively, to DPI microservice 620. In some embodiments, context X 660, 662, 664, and 666 are substantially identical.

In an embodiment, DPI microservice 620 is also stateless and may use the context provided by TCP/IP microservice 610 or 612 in transmission 644 or 656. DPI microservice 620 may load DPI processing state before processing the received data, but can perform some work (e.g., scheduling different DPI pattern state tables) based on the context. Transmitting the context to the DPI microservice therefore may obviate some amount of work by the DPI microservice. If TCP/IP microservice 610 fails and interface microservice 602 instead utilizes TCP/IP microservice 612, DPI microservice 620 may obtain the context from the transmission of reassembled TCP content in transmission 656.

Although FIG. 6 does not show a second packet, when a subsequent packet associated with the same context is received, interface microservice 602 may conduct a load balancing and select one of the TCP/IP microservices to forward the packet along with context X 660. In one embodiment, interface microservice 602 chooses to forward the second packet to TCP/IP microservice 612 via transmission path 650. TCP/IP microservice 612 performs some security processing, then transmits the second packet and context X 664 to DPI microservice 620 via transmission path 656. After performing some security processing, DPI microservice 620 responds to TCP/IP microservice 612 via transmission path 654, and TCP/IP microservice responds to interface microservice 602 via transmission path 658.

Summarizing the operation of an embodiment as illustrated by FIG. 6, an interface microservice transmits packets to a TCP/IP microservice along with a context that has been generated based on the contents of the packets. The transmission comprises a request to perform a security service (e.g., TCP/IP reassembly) for the packets to generate reassembled data. The TCP/IP microservice consults the received context to determine whether to obtain a context state, service state, or both, from a state repository to perform the security service. Reassembly is performed by the TCP/IP microservice, any modified state returned to the state repository and the reassembled data transmitted, along with the context, to a DPI microservice as a request to perform DPI processing.

Continuing the example illustrated by FIG. 6, the DPI microservice receives the reassembled data and context from the request to perform DPI security services transmitted by the TCP/IP microservice. The DPI microservice consults the received context to determine whether to obtain a context state, service state, or both, from a state repository to perform its security service. DPI inspection may be performed by the DPI microservice, any modified state returned to the state repository, and a response sent to the TCP/IP microservice.

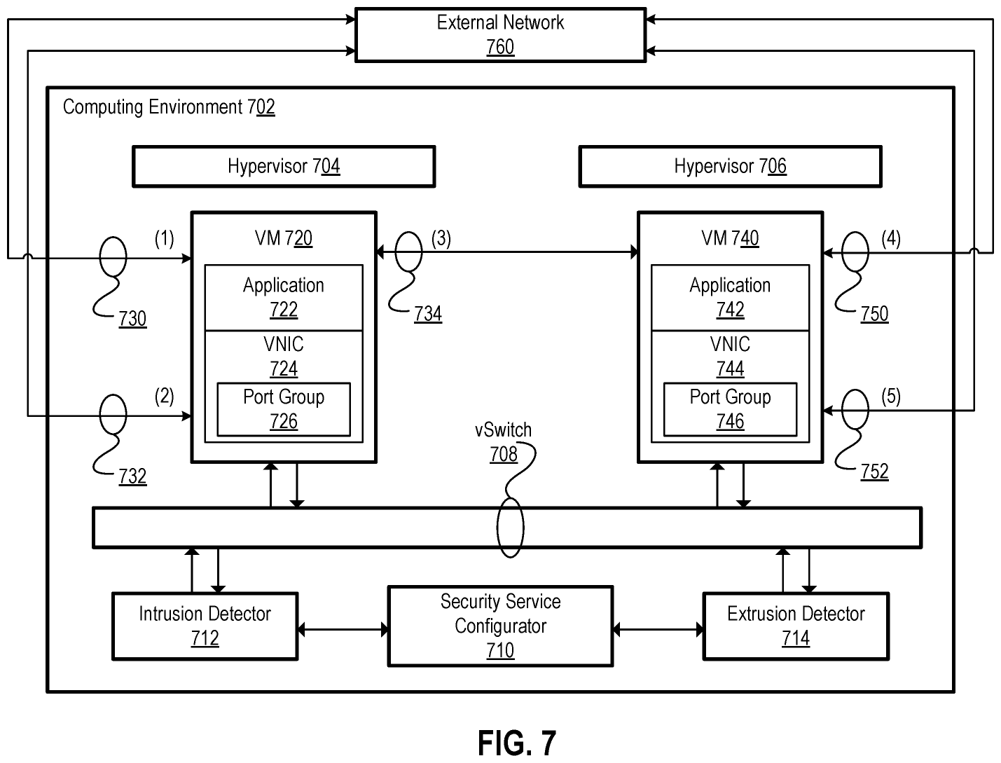

FIG. 7 is a block diagram illustrating security microservices configured to detect and configure network security based on the detection of a pivot of an intrusion in accordance with the disclosed embodiments. Specifically, the security microservices intercept and inspect traffic between external networks and internal networks as well as between virtual machines or other resource within the internal network and apply security policies to the traffic based on a configuration

In an embodiment, the system of FIG. 7 includes computing environment 702 on which at least hypervisors 704 and 706 are operating. Computing environment 702 includes one or more physical machines or computing devices having processing hardware and memory. The memory stores software to be executed by the processing hardware. In some embodiments, computing environment 702 is a single server, a cloud environment, or a datacenter. In one embodiment, hypervisors 704 and 706 are components implemented in software, hardware, firmware, or combinations thereof, and which manage the creation and operation of one or more virtual machines (VMs).

In one embodiment, hypervisor 704 creates and manages VM 720, and hypervisor 706 creates and manages VM 740. In one embodiment, each of VMs 720 and 740 include at least one application 722 and 742, respectively. Examples of application 722 and 742 include, but are not limited to, an operating system, a system application, and a user application. Each of VMs 720 and 740 also include a virtual network interface card (VNIC) 724 and 744, respectively. Each of VNICs 724 and 744 can be assigned to a port group (e.g., port groups 726 and 746, respectively). In one embodiment, the port group represents a port group identifier or another value indicating a specific port group. While in one embodiment, each of port groups 726 and 746 can be an identifier for a different port group, in another embodiment, port groups 726 and 746 can be assigned to a same port group. In some embodiments, hypervisors 704 and 706 and the VMs they support, VM 720 and 740, respectively, are located on different physical machines. In other embodiments, hypervisors 704 and 706 and the VMs they support are located on the same physical machine.

In FIG. 7, computing environment 702 includes security service configurator 710, which operates intrusion detector 712 and extrusion detector 714. In one embodiment, intrusion detector 712 and extrusion detector 714 are security microservices (e.g., microservices 108-122) providing security services under the control and configuration of a security service (e.g., security service 124) configured to monitor and analyze network traffic passing through computing environment 702. In one embodiment, security service configurator 710, intrusion detector 712, and extrusion detector 714 are located on one or more physical machines. While in one embodiment, one or more of security service configurator 710, intrusion detector 712, and extrusion detector 714 are located on a same physical machine as hypervisors 704 or 706, in other embodiments, security service configurator 710, intrusion detector 712, and extrusion detector 714 are located on one or more separate physical machines from hypervisors 704 or 706. In one embodiment, security service configurator 710 determines, among other things, the rules used by intrusion detector 712 and extrusion detector 714 including what network traffic to inspect, how the network traffic is inspected and what actions are taken based on the results of such inspections. Security service configurator 710 can be a single microservice or multiple microservices (e.g., microservices 108-122) operating responsive to administrator settings or configuration. In one embodiment, security service configurator 710 provides an application programming interface (API) such that other programs, scripts, or services may access the settings or configuration as well as access results or reports of the security service processing. Intrusion detector 712 detects attempts from externals sources (e.g., attackers) to gain access to a network or other internal device (e.g., attempting to login, scanning network, probing for IP addresses associated with the network, attempting to locate potential exploits, etc.). For example, intrusion detector 712 detects malicious network activity received by VM 720 from external network 760 via network traffic 730 and/or 732. Intrusion detector 712 detects these attempts based on characteristics of network traffic, including, but not limited to, the frequency of network traffic and the source of network traffic. Extrusion detector 714 detects and analyzes network traffic exiting, or attempting to exit, the network or internal device. For example, extrusion detector 714 identifies product source code, confidential information (e.g., customer data, financial data, etc.), and other types of data that would typically not be sent out of the network or internal device. For example, extrusion detector 714 detects network activity directed from the internal network (e.g., computing environment 702 and/or VM 740) to external network 760 via network traffic 750 and/or 752. Such data may include personally identifiable information (PII) such as credit card numbers, social security numbers, etc., that are subject to regulatory compliance and confidential information such as source code, marketing and sales information, etc., that constitute trade secrets or confidential information. Typically, an extrusion attempt is tied to an earlier intrusion that allowed the attacker into the system.

In one embodiment, the system of FIG. 7 also includes a virtual switch (vSwitch) 708. In some embodiments, vSwitch 708 is integrated into or otherwise part of hypervisors 704 and/or 706, configured via hypervisors 704 and/or 706, or some combination thereof. In one embodiment, vSwitch 708 facilitates communications between VMs 720 and 740 and/or between either of VMs 720 and 740 and external network 760. In one embodiment, vSwitch 708, utilizing one or more microservices (not pictured) intercepts network traffic associated with VM 720 and VM 740, including network traffic directed to/from external network 760 and network traffic sent between VM 720 and 740. For example, an interface microservice in VM 720 intercepts network traffic from external network 760 or VM 740 and redirects the intercepted network traffic through vSwitch 708 to intrusion detector 712 to process and analyze the network traffic. After intrusion detector 712 completes its analysis, intrusion detector routes the network traffic back to VM 720 via vSwitch 708. In an alternative embodiment, intrusion detector 712 analyzes a copy of the network traffic in parallel with the network traffic being sent to VM 720.

FIG. 7 further includes network traffic 730, 732, 734, 750, and 752. At (1), VM 720 receives an intrusion attempt in network traffic 730 received from external network 760. In one embodiment, the intrusion attempt is an attempt from an attacker to probe ports (e.g., of VM 720). In another embodiment, the intrusion attempt is an 7 attempt to inject material into return data. For example, assuming application 722 has a weak browser or stack, network traffic 730 can include an exploit that allows a buffer overflow. At (2), VM 720 receives network traffic 732, where network traffic 732 is an intrusion event received from external network 760. In one embodiment, an intrusion event includes a payload or malware that is directed at VM 720 based on the exploit identified by the attacker at (1) via the intrusion attempt in network traffic 730. For example, network traffic 732 can include a link to a location storing software that attempts an extrusion, including a command and control software or an encryption trojan from a server in a foreign country.

In one embodiment, where an attempted extrusion is performed from the same VM upon which the intrusion occurred (e.g., VM 720), extrusion detector 714 identifies or captures the extrusion attempt as a result of intrusion detector 712 detecting the earlier intrusion attempt or event. For example, because intrusion detector 712 detected the intrusion, security service configurator 710 increases (or strengthens) the security rules for extrusion detector 714, as applied to network traffic leaving from VM 720 or hypervisor 704. However, where the attempted extrusion is performed from a different VM from which the intrusion occurred, extrusion detector 714 may not as readily be able to identify the attempted extrusion as being part of an attack.

At (3), VM 740 receives network traffic 734 from VM 720. In one embodiment, network traffic 734 is identifiable as a pivot, where the malware downloaded as part of an intrusion on one system (e.g., VM 720) attempts to migrate to another resource or system (e.g., VM 740) within an internal network (e.g., computing environment 702). For example, if the malware cannot compromise any data in VM 720, the malware attempts to access another application (e.g., by performing an SSH login to application 742 in VM 740). In one embodiment, security service configurator 710 identifies indications of pivot, including identifying network traffic traversing systems and resources internally within a network (e.g., east-west traffic), such as detecting SSH transmissions from VM 720 (a potentially compromised virtual machine) to VM 740 (a machine with no appearance of compromise). As an example, if VM 720 had no indication of being compromised, the detection of an SSH transmission to VM 740 may not trigger security service configurator 710 to adjust rules or settings for VM 740. However, the security service configurator 710 detecting or having knowledge of the potential compromise of VM 720 would recognize the communication from a resource in VM 720 to a resource in VM 740 as an example of an indicator of pivot (e.g. that the attack on VM 720 has pivoted to VM 740). In one embodiment, security service configurator 710 identifies the indications of pivot in real-time.

In response to detecting the indication of pivot, security service configurator 710 modifies the security rules for extrusion detector 714 to increase or strengthen the security processing performed on network traffic leaving from VM 740 or hypervisor 706 and directed to outside of the internal network, e.g., to external network 760.

At (4), an extrusion attempt is performed via network traffic 750, where network traffic 750 is directed from a resource or system in the internal network to external network 760. For example, network traffic 750 may include a ping to a domain that is located in a foreign country. In a traditional system, security systems do not have a real-time understanding that network traffic sent from VM 740 should be treated with the same level of risk as network traffic sent from VM 720 (e.g., the system upon which intrusion detector 712 detected a previous intrusion). However, because security service configurator 710 detected the indications of pivot (e.g., network traffic 734), security service configurator 710 modifies the configuration and/or rules of extrusion detector 714. For example, security service configurator 710 configures extrusion detector 714 to analyze a greater amount of network traffic being sent from VM 740 or increase the restriction on what network traffic is allowed to be sent from VM 740. Thus, security service configurator 710 identifying the indications of pivot results in other systems (e.g., VM 740) inheriting and applying the higher security policy towards network traffic being sent that would be applied to the system that was the direct recipient of an intrusion attempt. For example, when extrusion detector 714 detects network traffic 750, because of the increased risk of the network traffic as determined from the reconfigured security policy, extrusion detector 714 blocks network traffic 750.

At (5), assuming the extrusion detector 714 did not block network traffic 750 from leaving from VM 740 (e.g., because there was no indication of data leakage), an extrusion event is performed via network traffic 752 directed from a resource or system in the internal network to external network 760. In one embodiment, an extrusion event includes network traffic that includes data actually leaving the internal network directed to an external network or an attempt to send network traffic that includes data from the internal network to the external network. In one example, network traffic 752 includes source code or other secure data from VM 740 directed to a domain that is located in a foreign country. In one embodiment, because of the new or reconfigured security policy, extrusion detector 714 detects and blocks the extrusion event in network traffic 752, thereby preventing the data leakage of sensitive data to an attacker.

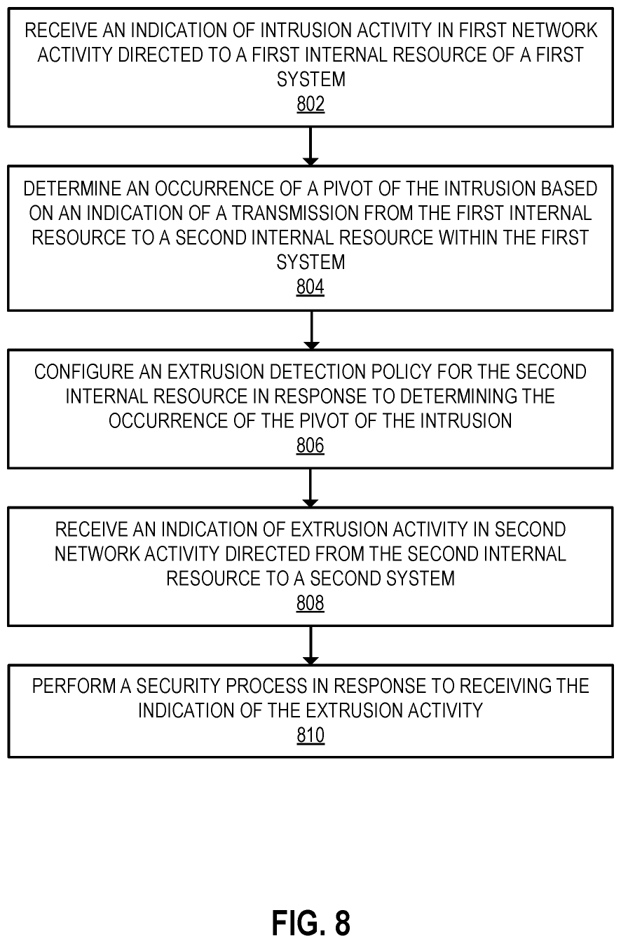

FIG. 8 is a flow diagram illustrating a process for reconfiguring security policies in response to detecting a pivot of an intrusion in accordance with an embodiment. For ease of understanding, the description of FIG. 8 below references components of the networked environments of FIGS. 1 and 7, however, it is not limited to those components. In one embodiment, a security service configurator performs the actions described below. Security service configurator 710 can be a microservice or multiple microservices (e.g., microservices 108-122) operating responsive to settings or configuration. In one embodiment, the security service configurator (e.g., security service configurator 710) receives instructions to perform the actions described below. In one embodiment, security service configurator 710 receives instructions from a security service (e.g., security service 124). Although FIG. 8 describes operations performed by a security service configurator, some or all of the operations described in FIG. 8 can be performed by a management microservice, configuration microservice, another type of microservice, an application, or any other computer-executable logic.

At block 802, a security service configurator receives an indication of intrusion activity in first network activity directed to a first internal resource of a first system. The security service configurator receives the indication of the intrusion activity from an intrusion detector or from an intermediary service that receives the indication of the intrusion activity from an intrusion detector.

In one embodiment, the intrusion activity can include an intrusion attempt or intrusion event. In one embodiment, an intrusion attempt includes an attempt from an attacker to probe ports associated with the first system or inject material into return data. In one embodiment, an intrusion event includes a payload or malware that is directed at the first system based on the exploit identified by the attacker (e.g., in a previous intrusion attempt). For example, the intrusion event can include a link to a location storing software that attempts an extrusion of data stored in the first system or another system within a same internal network as the first system. In one embodiment, the activity includes an indication of success of an intrusion of the first internal resource of the first system. For example, the security service configurator can consider an attempt to establish a connection to an external server and download bulk data (such as malware, command and control software, analysis software or other potentially compromising software) as an indication of success of an intrusion. Similarly, the security service configurator can consider attempts to resolve the DNS entries of suspicious URLs as an indication of success of an intrusion.

At block 804, the security service configurator determines an occurrence of a pivot of the intrusion from the first internal resource to a second internal resource within the first system. In one embodiment, the security service configurator determines the occurrence of a pivot of the intrusion based on previous information of the intrusion activity directed to and/or occurring on the first internal resource (e.g., based on the indication of intrusion activity) and based on an indication that the payload or malware downloaded based on the intrusion activity migrating or attempting to migrate from one resource or system (e.g., the first internal resource of the first system) to another resource or system within the same internal network (e.g., the second internal resource of the first system). For example, a pivot occurs when the first internal resource cannot be compromised (e.g., it is protected from data leakage) or does not have direct access to the type of data targeted by the intrusion. As a result, the intrusion attempts to access other resources within the internal network having access to the target data or that the data can be extruded from.

At block 806, the security service configurator configures an extrusion detection policy for the second internal resource in response to determining the occurrence of the pivot of the intrusion from the first internal resource to the second internal resource. In one embodiment, the security service configurator generates a new extrusion detection policy or modifies/reconfigures an existing extrusion detection policy. While in one embodiment, the security service configurator reconfigures the extrusion detection policy for the second internal resource by using predefined security policies or templates, in other embodiments, the security service configurator dynamically creates new security policies.

For example, the security service configurator modifies the security rules for resources or systems within the first system, including the second internal resource, to increase or strengthen the security processing performed on network traffic leaving from the second internal resource that is directed to outside of the internal network. In one embodiment, resources and systems modified by the security service configurator include one or more of logging devices, databases, network traffic taps and sampling systems, correlation systems and machine learning systems. In one embodiment, strengthening the operating of these systems includes one or more of changing the operating mode, changing rules or policies applied to network traffic, increasing storage allocation, and increasing the number and types of analyses performed on network traffic.

The increased security processing can be applied to network traffic directed to specific external networks or to all external networks. In one embodiment, the security service configurator strengthens the security processing of network traffic leaving the second internal resource from logging the network traffic to analyzing or blocking all or some of the network traffic. In other embodiments, the security service configurator increases a risk level on network traffic leaving the second internal resource.

In one embodiment, the security service configurator pushes or otherwise sends the new or reconfigured extrusion detection policy to the extrusion detector for application to subsequent network traffic analyzed by the extrusion detector.

At block 808, the security service configurator receives an indication of extrusion activity in second network activity directed from the second internal resource to a second system, where the second system is external to the first system. The security service configurator receives the indication of the extrusion activity from an extrusion detector. In one embodiment, the extrusion activity can include an extrusion attempt or an extrusion event. In one embodiment, an extrusion attempt includes an attempt to communicate with an external network. An example extrusion attempt is a ping to a domain that is located in a foreign country. In one embodiment, an extrusion event includes an attempt to send data from an internal network (e.g., the first system) to an external network (e.g., the second system). Continuing the example, an extrusion event can include network traffic including source code or other secure data being directed to the domain that is located in the foreign country. In one embodiment, the extrusion activity from the second internal resource occurs as a result of the pivot of the intrusion from the first internal resource to the second internal resource.

At block 810, the security service configurator performs a security process in response to receiving the indication of the extrusion activity. In one embodiment, performing the security process includes the security service configurator blocking some or all of the second network activity directed from the second internal resource to the second system. In one embodiment, performing the security process includes the security service configurator selecting different patterns for data leakage protection or changing thresholds on pattern matches used during data leakage protection. For example, the security service configurator can switch the second internal resource from a lower risk pattern to a higher risk pattern and/or increase the risk threshold for analyses of network traffic leaving the second internal resource.

According to one embodiment, the techniques described herein are implemented by one or more special-purpose computing devices. The special-purpose computing devices may be desktop computer systems, portable computer systems, handheld devices, networking devices or any other device that incorporates hard-wired, program logic, or both to implement the techniques. The special-purpose computing devices may be hard-wired to perform the techniques or may include digital electronic devices such as one or more application-specific integrated circuits (ASICs) or field programmable gate arrays (FPGAs) that are persistently programmed to perform the techniques or may include one or more general purpose hardware processors programmed to perform the techniques pursuant to program instructions in firmware, memory, other storage, or a combination thereof. Such special-purpose computing devices may also combine custom hard-wired logic, ASICs, or FPGAs with custom programming to accomplish the techniques.

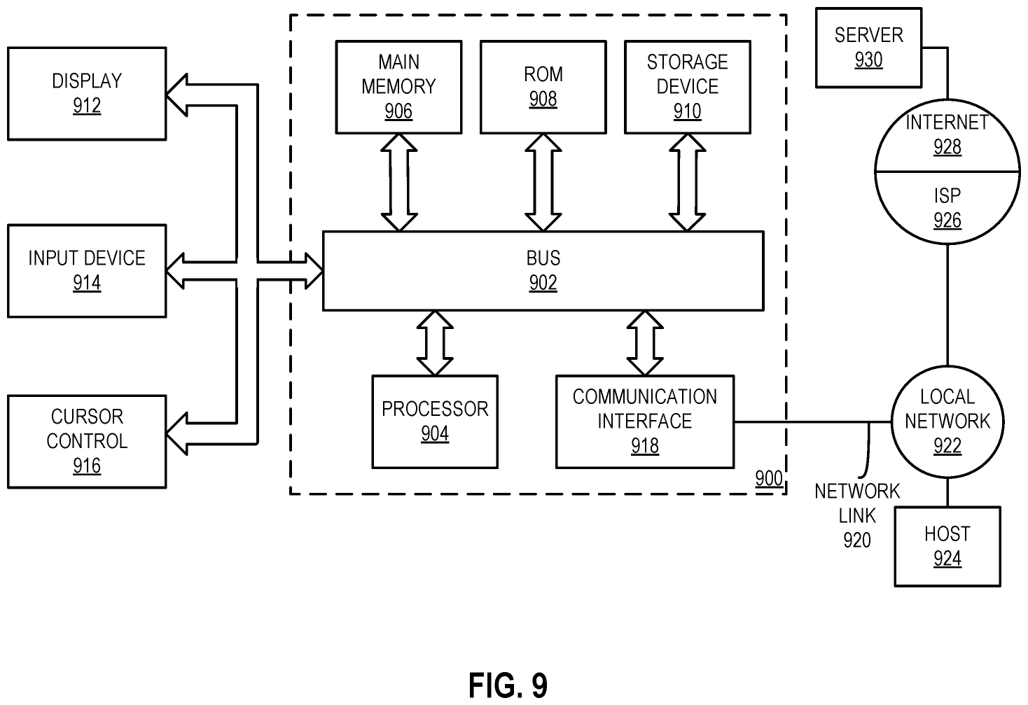

FIG. 9 is a block diagram that illustrates a computer system 900 utilized in implementing the above-described techniques in accordance with some of the disclosed embodiments. Computer system 900 may be, for example, a desktop computing device, laptop computing device, tablet, smartphone, server appliance, computing mainframe, multimedia device, handheld device, networking apparatus, or any other suitable device.

Computer system 900 includes one or more buses 902 or other communication mechanism for communicating information, and one or more hardware processors 904 coupled with buses 902 for processing information. Hardware processors 904 may be, for example, general purpose microprocessors. Buses 902 may include various internal and/or external components, including, without limitation, internal processor or memory busses, a Serial ATA bus, a PCI Express bus, a Universal Serial Bus, a HyperTransport bus, an Infiniband bus, and/or any other suitable wired or wireless communication channel.

Computer system 900 also includes a main memory 906, such as a random-access memory (RAM) or other dynamic or volatile storage device, coupled to bus 902 for storing information and instructions to be executed by processor 904. Main memory 906 also may be used for storing temporary variables or other intermediate information during execution of instructions to be executed by processor 904. Such instructions, when stored in non-transitory storage media accessible to processor 904, render computer system 900 a special-purpose machine that is customized to perform the operations specified in the instructions.

Computer system 900 further includes one or more read only memories (ROM) 908 or other static storage devices coupled to bus 902 for storing static information and instructions for processor 904. One or more storage devices 910, such as a solid-state drive (SSD), magnetic disk, optical disk, or other suitable non-volatile storage device, is provided and coupled to bus 902 for storing information and instructions.

Computer system 900 may be coupled via bus 902 to one or more displays 912 for presenting information to a computer user. For instance, computer system 900 may be connected via a High-Definition Multimedia Interface (HDMI) cable or other suitable cabling to a Liquid Crystal Display (LCD) monitor, and/or via a wireless connection such as peer-to-peer Wi-Fi Direct connection to a Light-Emitting Diode (LED) television. Other examples of suitable types of displays 912 may include, without limitation, plasma display devices, projectors, cathode ray tube (CRT) monitors, electronic paper, virtual reality headsets, braille terminal, and/or any other suitable device for outputting information to a computer user. In one embodiment, any suitable type of output device, such as, for instance, an audio speaker or printer, may be utilized instead of a display 912.

One or more input devices 914 are coupled to bus 902 for communicating information and command selections to processor 904. One example of an input device 914 is a keyboard, including alphanumeric and other keys. Another type of user input device 914 is cursor control 916, such as a mouse, a trackball, or cursor direction keys for communicating direction information and command selections to processor 904 and for controlling cursor movement on display 912. This input device typically has two degrees of freedom in two axes, a first axis (e.g., x) and a second axis (e.g., y), that allows the device to specify positions in a plane. Yet other examples of suitable input devices 914 include a touch-screen panel affixed to a display 912, cameras, microphones, accelerometers, motion detectors, and/or other sensors. In one embodiment, a network-based input device 914 may be utilized. In such an embodiment, user input and/or other information or commands may be relayed via routers and/or switches on a Local Area Network (LAN) or other suitable shared network, or via a peer-to-peer network, from the input device 914 to a network link 920 on the computer system 900.

A computer system 900 may implement techniques described herein using customized hard-wired logic, one or more ASICs or FPGAs, firmware and/or program logic which in combination with the computer system causes or programs computer system 900 to be a special-purpose machine. According to one embodiment, the techniques herein are performed by computer system 900 in response to processor 904 executing one or more sequences of one or more instructions contained in main memory 906. Such instructions may be read into main memory 906 from another storage medium, such as storage device 910. Execution of the sequences of instructions contained in main memory 906 causes processor 904 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 910. Volatile media includes dynamic memory, such as main memory 906. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, an EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 902. Transmission media can also take the form of acoustic or light waves, such as those generated during radio-wave and infra-red data communications.

Various forms of media may be involved in carrying one or more sequences of one or more instructions to processor 904 for execution. For example, the instructions may initially be carried on a magnetic disk or a solid-state drive of a remote computer. The remote computer can load the instructions into its dynamic memory and use a modem to send the instructions over a network, such as a cable network or cellular network, as modulate signals. A modem local to computer system 900 can receive the data on the network and demodulate the signal to decode the transmitted instructions. Appropriate circuitry can then place the data on bus 902. Bus 902 carries the data to main memory 906, from which processor 904 retrieves and executes the instructions. The instructions received by main memory 906 may optionally be stored on storage device 910 either before or after execution by processor 904.

A computer system 900 may also include, in one embodiment, one or more communication interfaces 918 coupled to bus 902. A communication interface 918 provides a data communication coupling, typically two-way, to a network link 920 that is connected to a local network 922. For example, a communication interface 918 may be an integrated services digital network (ISDN) card, cable modem, satellite modem, or a modem to provide a data communication connection to a corresponding type of telephone line. As another example, the one or more communication interfaces 918 may include a local area network (LAN) card to provide a data communication connection to a compatible LAN. As another example, the one or more communication interfaces 918 may include a wireless network interface controller, such as an 802.11-based controller, Bluetooth controller, Long Term Evolution (LTE) modem, and/or other types of wireless interfaces. In any such implementation, communication interface 918 sends and receives electrical, electromagnetic, or optical signals that carry digital data streams representing various types of information.

Network link 920 typically provides data communication through one or more networks to other data devices. For example, network link 920 may provide a connection through local network 922 to a host computer 924 or to data equipment operated by a Service Provider 926. Service Provider 926, which may for example be an Internet Service Provider (ISP), in turn provides data communication services through a wide area network, such as the world-wide packet data communication network now commonly referred to as the “Internet” 928. Local network 922 and Internet 928 both use electrical, electromagnetic or optical signals that carry digital data streams. The signals through the various networks and the signals on network link 920 and through communication interface 918, which carry the digital data to and from computer system 900, are example forms of transmission media.

In one embodiment, computer system 900 can send messages and receive data, including program code and/or other types of instructions, through the network(s), network link 920, and communication interface 918. In the Internet example, a server 930 might transmit a requested code for an application program through Internet 928, Service Provider 926, local network 922 and communication interface 918. The received code may be executed by processor 904 as it is received, and/or stored in storage device 910, or other non-volatile storage for later execution. As another example, information received via a network link 920 may be interpreted and/or processed by a software component of the computer system 900, such as a web browser, application, or server, which in turn issues instructions based thereon to a processor 904, possibly via an operating system and/or other intermediate layers of software components.

In one embodiment, some or all of the systems described herein may be or comprise server computer systems, including one or more computer systems 900 that collectively implement various components of the system as a set of server-side processes. The server computer systems may include web server, application server, database server, and/or other conventional server components that certain above-described components utilize to provide the described functionality. The server computer systems may receive network-based communications comprising input data from any of a variety of sources, including without limitation user-operated client computing devices such as desktop computers, tablets, or smartphones, remote sensing devices, and/or other server computer systems.

In one embodiment, certain server components may be implemented in full or in part using “cloud”-based components that are coupled to the systems by one or more networks, such as the Internet. The cloud-based components may expose interfaces by which they provide processing, storage, software, and/or other resources to other components of the systems. In one embodiment, the cloud-based components may be implemented by third-party entities, on behalf of another entity for whom the components are deployed. In other embodiments, however, the described systems may be implemented entirely by computer systems owned and operated by a single entity.

In one embodiment, an apparatus comprises a processor and is configured to perform any of the foregoing methods. In one embodiment, a non-transitory computer-readable storage medium, storing software instructions, which when executed by one or more processors cause performance of any of the foregoing methods.

Although some embodiments disclosed herein involve data handling and distribution in the context of hardware execution units and logic circuits, other embodiments can be accomplished by way of a data or instructions stored on a non-transitory machine-readable, tangible medium, which, when performed by a machine, cause the machine to perform functions consistent with at least one embodiment. In one embodiment, functions associated with embodiments of the present disclosure are embodied in computer-executable instructions. The instructions can be used to cause a general-purpose or special-purpose hardware processor that is programmed with the instructions to perform the steps of the at least one embodiment. Embodiments of the present invention may be provided as a computer program product or software which may include a machine or computer-readable medium having stored thereon instructions which may be used to program a computer (or other electronic devices) to perform one or more operations according to the at least one embodiment. Alternatively, steps of embodiments may be performed by specific hardware components that contain fixed-function logic for performing the steps, or by any combination of programmed computer components and fixed-function hardware components.

Instructions used to program circuits to perform at least one embodiment can be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the non-transitory computer-readable medium includes any type of tangible machine-readable medium suitable for storing or transmitting electronic instructions or information in a form readable by a machine (e.g., a computer).

Examples of embodiments of methods, apparatuses, systems, etc. detailed herein are listed below.

In some embodiments, a computer-implemented method comprises: receiving an indication of intrusion activity in first network activity directed to a first internal resource of a first system. The intrusion activity includes an indication of success of an intrusion of the first internal resource. The method further comprises determining an occurrence of a pivot of the intrusion, wherein the determination of the occurrence of the pivot of the intrusion is based on an indication of a transmission from the first internal resource to a second internal resource within the first system. The method further comprises configuring an extrusion detection policy for the second internal resource in response to determining the occurrence of the pivot of the intrusion from the first internal resource to the second internal resource. The method further comprises receiving an indication of extrusion activity in second network activity directed from the second internal resource to a second system, the second system external to the first system. The method further comprises performing a security process in response to receiving the indication of the extrusion activity.

In some embodiments, one or more of the following applies: 1) performing the security process in response to receiving the indication of the extrusion activity includes blocking the second network activity directed from the second internal resource to the second system; 2) configuring the extrusion detection policy for the second internal resource includes increasing a risk level on network traffic directed from the second internal resource to the second system; 3) configuring the extrusion detection policy for the second internal resource includes directing an extrusion detector to analyze all network traffic directed from the second internal resource to the second system; 4) configuring the extrusion detection policy for the second internal resource includes pushing the extrusion detection policy to an extrusion detector; 5) determining the occurrence of the pivot of the intrusion occurs in real-time; and 6) performing the security process in response to receiving the indication of the extrusion activity includes selecting different patterns for data leakage protection or changing thresholds on pattern matches used during data leakage protection.

In some embodiments, one or more non-transitory computer-readable storage media store instructions which, when executed by one or more hardware processors, cause performance of a method comprising: receiving an indication of intrusion activity in first network activity directed to a first internal resource of a first system. The intrusion activity includes an indication of success of an intrusion of the first internal resource. The method further comprises determining an occurrence of a pivot of the intrusion, wherein the determination of the occurrence of the pivot of the intrusion is based on an indication of a transmission from the first internal resource to a second internal resource within the first system. The method further comprises configuring an extrusion detection policy for the second internal resource in response to determining the occurrence of the pivot of the intrusion from the first internal resource to the second internal resource. The method further comprises receiving an indication of extrusion activity in second network activity directed from the second internal resource to a second system, the second system external to the first system. The method further comprises performing a security process in response to receiving the indication of the extrusion activity.

In some embodiments, one or more of the following applies: 1) performing the security process in response to receiving the indication of the extrusion activity includes blocking the second network activity directed from the second internal resource to the second system; 2) configuring the extrusion detection policy for the second internal resource includes increasing a risk level on network traffic directed from the second internal resource to the second system; 3) configuring the extrusion detection policy for the second internal resource includes directing an extrusion detector to analyze all network traffic directed from the second internal resource to the second system; 4) configuring the extrusion detection policy for the second internal resource includes pushing the extrusion detection policy to an extrusion detector; 5) determining the occurrence of the pivot of the intrusion occurs in real-time; and 6) performing the security process in response to receiving the indication of the extrusion activity includes selecting different patterns for data leakage protection or changing thresholds on pattern matches used during data leakage protection.

In some embodiments, an apparatus comprises: one or more hardware processors; and memory coupled to the one or more hardware processors, the memory storing instructions which, when executed by the one or more hardware processors, cause the apparatus to: receive an indication of intrusion activity in first network activity directed to a first internal resource of a first system. The intrusion activity includes an indication of success of an intrusion of the first internal resource. The instructions further cause the apparatus to determine an occurrence of a pivot of the intrusion, wherein the determination of the occurrence of the pivot of the intrusion is based on an indication of a transmission from the first internal resource to a second internal resource within the first system. The instructions further cause the apparatus to configure an extrusion detection policy for the second internal resource in response to determining the occurrence of the pivot of the intrusion from the first internal resource to the second internal resource. The instructions further cause the apparatus to receive an indication of extrusion activity in second network activity directed from the second internal resource to a second system, the second system external to the first system. The instructions further cause the apparatus to perform a security process in response to receiving the indication of the extrusion activity.

In some embodiments, one or more of the following applies: 1) performing the security process in response to receiving the indication of the extrusion activity includes blocking the second network activity directed from the second internal resource to the second system; 2) configuring the extrusion detection policy for the second internal resource includes increasing a risk level on network traffic directed from the second internal resource to the second system; 3) configuring the extrusion detection policy for the second internal resource includes directing an extrusion detector to analyze all network traffic directed from the second internal resource to the second system; 4) configuring the extrusion detection policy for the second internal resource includes pushing the extrusion detection policy to an extrusion detector; 5) determining the occurrence of the pivot of the intrusion occurs in real-time; and 6) performing the security process in response to receiving the indication of the extrusion activity includes selecting different patterns for data leakage protection or changing thresholds on pattern matches used during data leakage protection.

What is claimed is:

1. A computer-implemented method comprising:
receiving an indication of intrusion activity in first network activity directed to a first internal resource of a first system, the intrusion activity including an indication of success of an intrusion of the first internal resource;
determining an occurrence of a pivot of the intrusion, wherein the determination of the occurrence of the pivot of the intrusion is based on an indication of a transmission from the first internal resource to a second internal resource within the first system;
configuring an extrusion detection policy for the second internal resource in response to determining the occurrence of the pivot of the intrusion from the first internal resource to the second internal resource;
receiving an indication of extrusion activity in second network activity directed from the second internal resource to a second system, the second system external to the first system; and
performing a security process in response to receiving the indication of the extrusion activity.

2. The computer-implemented method of claim 1, wherein performing the security process in response to receiving the indication of the extrusion activity includes blocking the second network activity directed from the second internal resource to the second system.

3. The computer-implemented method of claim 1, wherein configuring the extrusion detection policy for the second internal resource includes increasing a risk level on network traffic directed from the second internal resource to the second system.

4. The computer-implemented method of claim 1, wherein configuring the extrusion detection policy for the second internal resource includes directing an extrusion detector to analyze all network traffic directed from the second internal resource to the second system.

5. The computer-implemented method of claim 1, wherein configuring the extrusion detection policy for the second internal resource includes pushing the extrusion detection policy to an extrusion detector.

6. The computer-implemented method of claim 1, wherein determining the occurrence of the pivot of the intrusion occurs in real-time.

7. The computer-implemented method of claim 1, wherein performing the security process in response to receiving the indication of the extrusion activity includes selecting different patterns for data leakage protection or changing thresholds on pattern matches used during data leakage protection.

8. One or more non-transitory computer-readable storage media storing instructions which, when executed by one or more hardware processors, cause performance of a method comprising:
receiving an indication of intrusion activity in first network activity directed to a first internal resource of a first system, the intrusion activity including an indication of success of an intrusion of the first internal resource;
determining an occurrence of a pivot of the intrusion, wherein the determination of the occurrence of the pivot of the intrusion is based on an indication of a transmission from the first internal resource to a second internal resource within the first system;
configuring an extrusion detection policy for the second internal resource in response to determining the occurrence of the pivot of the intrusion from the first internal resource to the second internal resource;
receiving an indication of extrusion activity in second network activity directed from the second internal resource to a second system, the second system external to the first system; and
performing a security process in response to receiving the indication of the extrusion activity.

9. The non-transitory computer-readable storage media of claim 8, wherein performing the security process in response to receiving the indication of the extrusion activity includes blocking the second network activity directed from the second internal resource to the second system.

10. The non-transitory computer-readable storage media of claim 8, wherein configuring the extrusion detection policy for the second internal resource includes increasing a risk level on network traffic directed from the second internal resource to the second system.

11. The non-transitory computer-readable storage media of claim 8, wherein configuring the extrusion detection policy for the second internal resource includes directing an extrusion detector to analyze all network traffic directed from the second internal resource to the second system.

12. The non-transitory computer-readable storage media of claim 8, wherein configuring the extrusion detection policy for the second internal resource includes pushing the extrusion detection policy to an extrusion detector.

13. The non-transitory computer-readable storage media of claim 8, wherein determining the occurrence of the pivot of the intrusion occurs in real-time.

14. The non-transitory computer-readable storage media of claim 8, wherein performing the security process in response to receiving the indication of the extrusion activity includes selecting different patterns for data leakage protection or changing thresholds on pattern matches used during data leakage protection.

15. An apparatus comprising:
one or more hardware processors; and
memory coupled to the one or more hardware processors, the memory storing instructions which, when executed by the one or more hardware processors, causes the apparatus to:
receive an indication of intrusion activity in first network activity directed to a first internal resource of a first system, the intrusion activity including an indication of success of an intrusion of the first internal resource;
determine an occurrence of a pivot of the intrusion, wherein the determination of the occurrence of the pivot of the intrusion is based on an indication of a transmission from the first internal resource to a second internal resource within the first system;
configure an extrusion detection policy for the second internal resource in response to determining the occurrence of the pivot of the intrusion from the first internal resource to the second internal resource;
receive an indication of extrusion activity in second network activity directed from the second internal resource to a second system, the second system external to the first system; and
perform a security process in response to receiving the indication of the extrusion activity.

16. The apparatus of claim 15, wherein performing the security process in response to receiving the indication of the extrusion activity includes blocking the second network activity directed from the second internal resource to the second system.

17. The apparatus of claim 15, wherein configuring the extrusion detection policy for the second internal resource includes increasing a risk level on network traffic directed from the second internal resource to the second system.

18. The apparatus of claim 15, wherein configuring the extrusion detection policy for the second internal resource includes directing an extrusion detector to analyze all network traffic directed from the second internal resource to the second system.

19. The apparatus of claim 15, wherein configuring the extrusion detection policy for the second internal resource includes pushing the extrusion detection policy to an extrusion detector.

20. The apparatus of claim 15, wherein performing the security process in response to receiving the indication of the extrusion activity includes selecting different patterns for data leakage protection or changing thresholds on pattern matches used during data leakage protection.
